(19) United States
(12) Patent Application Publication
(10) Pub. No.: US 2014/0003920 A1
(43) Pub. Date: Jan. 2, 2014

(54) FLOW METERING ANTI-ROTATION OUTER DIAMETER (OD) HEX NUT

(71) Applicant: Jonathan Ariel Scott, Tolland, CT (US)

(72) Inventor: Jonathan Ariel Scott, Tolland, CT (US)

(73) Assignee: UNITED TECHNOLOGIES CORPORATION, Hartford, CT (US)

(21) Appl. No.: 13/540,009

(22) Filed: Jul. 2, 2012

(51) Int. Cl. F04D 29/58; F16B 37/00

(52) U.S. Cl. 415/177; 411/427

(57) ABSTRACT

An outer diameter (OD) hex nut secures a hollow cooling rod to an outer case of an engine. The OD hex nut includes a flange portion and a hollow tube portion. The flange portion includes a central aperture for receiving cooling airflow and a plurality of vernier holes located circumferentially around the flange portion. The hollow tube portion extends from the flange portion and is in fluid communication with the central aperture to receive cooling airflow for distribution to the hollow cooling rod.

### BACKGROUND

The present invention is related to aircraft engines, and in particular to a mid-turbine frame portion of an aircraft engine.

Various aircraft engine topologies exist. In one topology, a mid-turbine frame is located between a high-pressure turbine portion and a low-pressure turbine portion. The mid-turbine frame supports rotor bearings both fore and aft. High temperatures associated with expanding, hot gases provided by the combustor require various portions associated with the mid-turbine frame to be cooled. To this end, hollow cooling rods are connected between an inner hub portion and an outer case portion of the mid-turbine frame. Typically, hollow cooling rods are bolted directly to the inner hub portion and the outer case.

### SUMMARY

The following are non-exclusive descriptions of possible embodiments of the present invention.

An outer diameter (OD) hex nut according to an exemplary embodiment of this disclosure secures a hollow cooling rod to an outer case of an engine. The OD hex nut includes a flange portion and a hollow tube portion. The flange portion includes a central aperture for receiving cooling airflow and a plurality of vernier holes located circumferentially around the flange portion. The hollow tube portion extends from the flange portion and is in fluid communication with the central aperture to receive cooling airflow for distribution to the hollow cooling rod.

In a further embodiment of any of the foregoing embodiments, the hollow tube portion may be threaded on a distal end for threaded engagement with a hollow cooling rod.

In a further embodiment of any of the foregoing embodiments may include a shoulder portion located around the central aperture of the flange portion for supporting a flow metering tube that extends into the hollow tube portion for engagement with the hollow cooling rod.

An apparatus for tensioning a hollow cooling rod and distributing cooling airflow to various location in a mid-turbine frame according to an exemplary embodiment of this disclosure includes an outer diameter (OD) hex nut having a flange portion and a hollow tube portion, wherein the flange portion includes a central aperture for receiving cooling airflow and a plurality of vernier holes located circumferentially around the central aperture. The hollow tube portion extends from the flange portion and is threaded on one end for threaded engagement with the hollow cooling rod, wherein the hollow tube portion is in fluid communication with the central aperture to deliver cooling airflow to the hollow cooling rod. At least one anti-rotation bolt is installed in one of the plurality of vernier holes and secured to an outer case of the mid-turbine frame to prevent rotation of the OD hex nut.

In a further embodiment, the OD hex nut may include a plurality of side apertures located on the hollow tube portion of the OD hex nut.

A further embodiment of any of the foregoing embodiments may include a flow metering tube positioned/located within the central aperture of the OD hex nut. The flow metering tube may include a flange portion that is supported by the OD hex nut and a tube portion that extends within the tube portion of the OD hex nut for engagement within the hollow cooling rod and a flow metering plate supported by the flow metering tube that includes a central aperture and a plurality of apertures located circumferentially around the flow metering plate. The central aperture may supply cooling airflow to the tube portion of the flow metering tube for supply to the hollow cooling rod, and wherein the plurality of apertures located circumferentially around the flow metering plate direct cooling airflow external to the tube portion of the flow metering tube for communication to an outer diameter of the mid-turbine frame via the plurality of side apertures located on the hollow tube portion of the OD hex nut.

A cooling apparatus for a mid-turbine frame according to an exemplary embodiment of this disclosure includes an outer case, an inner hub, a hollow cooling rod that extends from the inner hub to the outer case, and an outer diameter (OD) hux nut. In one embodiment, the OD hex nut includes a flange portion and a hollow tube portion, wherein the flange portion supports the OD hex nut against the outer case and includes a central aperture and a plurality of vernier holes, and wherein the hollow tube portion includes a threaded end for threaded engagement with the hollow cooling rod. The OD hex nut is tightened to tension the hollow cooling rod, and an anti-rotation bolt is threaded through one of the plurality of vernier holes into a bolt hole on the outer case to prevent the OD hex nut from rotating once installed and tensioned.

In a further embodiment, the OD hex nut may include a plurality of side apertures located on the hollow tube portion of the OD hex nut.

A further embodiment of any of the foregoing embodiments may include a flow metering tube and a flow metering plate. The flow metering tube may be located within the central aperture of the OD hex nut that includes a flange portion that is supported by the OD hex nut and a tube portion that extends within the tube portion of the OD hex nut for engagement within the hollow cooling rod. The flow metering plate is supported by the flow metering tube and includes a central aperture and a plurality of apertures located circumferentially around the flow metering plate, wherein the central aperture supplies cooling airflow to the tube portion of the flow metering tube for supply to the hollow cooling rod, and wherein the plurality of apertures located circumferentially around the flow metering plate direct cooling airflow external to the tube portion of the flow metering tube for communication to an outer diameter of the mid-turbine frame via the plurality of side apertures located on the hollow tube portion of the OD hex nut.

A further embodiment of any of the foregoing embodiments may include an external manifold attached to the OD hex nut that holds the metering plate in place on top of the flow metering tube and a cooling pipe that supplies cooling airflow to the external manifold for bifurcation and metering by the flow metering tube and the metering plate.

### BRIEF DESCRIPTION OF THE DRAWINGS

FIG. 1 is a schematic, cross-sectional view of a gas turbine engine according to an embodiment of the present invention.

FIG. 2 is a cross-sectional view of the mid-turbine frame portion of the gas turbine engine according to an embodiment of the present invention.

FIG. 3 is an isometric view of the outer diameter (OD) hex nut according to an embodiment of the present invention.

FIG. 4A is a perspective view of an installed OD hex nut and

FIG. 4B is a cross-sectional view of an installed OD hex nut according to an embodiment of the present invention.

### DETAILED DESCRIPTION

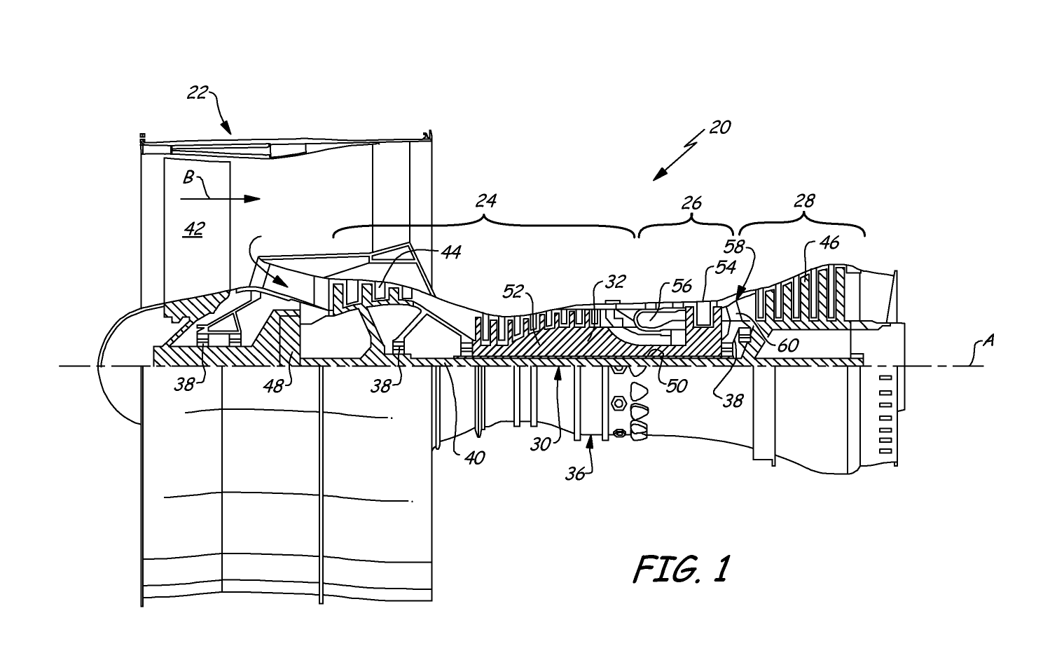

FIG. 1 schematically illustrates an example gas turbine engine 20 that includes fan section 22, compressor section 24, combustor section 26 and turbine section 28. Alternative engines might include an augmenter section (not shown) among other systems or features. Fan section 22 drives air along bypass flow path B while compressor section 24 draws air in along core flow path C where air is compressed and communicated to combustor section 26. In combustor section 26, air is mixed with fuel and ignited to generate a high pressure exhaust gas stream that expands through turbine section 28 where energy is extracted and utilized to drive fan section 22 and compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes low speed spool 30 and high speed spool 32 mounted for rotation about an engine central longitudinal axis A relative to an engine static structure 36 via several bearing systems 38. It should be understood that various bearing systems 38 at various locations may alternatively or additionally be provided.

Low speed spool 30 generally includes inner shaft 40 that connects fan 42 and low pressure (or first) compressor section 44 to low pressure (or first) turbine section 46. Inner shaft 40 drives fan 42 through a speed change device, such as geared architecture 48, to drive fan 42 at a lower speed than low speed spool 30. High-speed spool 32 includes outer shaft 50 that interconnects high pressure (or second) compressor section 52 and high pressure (or second) turbine section 54. Inner shaft 40 and outer shaft 50 are concentric and rotate via bearing systems 38 about engine central longitudinal axis A.

Combustor 56 is arranged between high pressure compressor 52 and high pressure turbine 54. In one example, high pressure turbine 54 includes at least two stages to provide a double stage high pressure turbine 54. In another example, high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of low pressure turbine 46 as related to the pressure measured at the outlet of low pressure turbine 46 prior to an exhaust nozzle.

Mid-turbine frame 58 of engine static structure 36 is arranged generally between high pressure turbine 54 and low pressure turbine 46. Mid-turbine frame 58 further supports bearing systems 38 in turbine section 28 as well as setting airflow entering low pressure turbine 46.

The core airflow C is compressed by low pressure compressor 44 then by high pressure compressor 52 mixed with fuel and ignited in combustor 56 to produce high speed exhaust gases that are then expanded through high pressure turbine 54 and low pressure turbine 46. Mid-turbine frame 58 includes vanes 60, which are in the core airflow path and function as an inlet guide vane for low pressure turbine 46. Utilizing vane 60 of mid-turbine frame 58 as the inlet guide vane for low pressure turbine 46 decreases the length of low pressure turbine 46 without increasing the axial length of mid-turbine frame 58. Reducing or eliminating the number of vanes in low pressure turbine 46 shortens the axial length of turbine section 28. Thus, the compactness of gas turbine engine 20 is increased and a higher power density may be achieved.

The disclosed gas turbine engine 20 in one example is a high-bypass geared aircraft engine. In a further example, gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, gas turbine engine 20 includes a bypass ratio greater than about ten (10:1) and the fan diameter is significantly larger than an outer diameter of low pressure compressor 44. It should be understood, however, that the above parameters are only exemplary of one embodiment of a gas turbine engine including a geared architecture and that the present disclosure is applicable to other gas turbine engines.

A significant amount of thrust is provided by bypass flow B due to the high bypass ratio. Fan section 22 of engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (“TSFC”)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/518.7) ^{0.5}]. The “Low corrected fan tip speed”, as disclosed herein according to one non-limiting embodiment, is less than about 1150 ft/second.

The example gas turbine engine includes fan 42 that comprises in one non-limiting embodiment less than about 26 fan blades. In another non-limiting embodiment, fan section 22 includes less than about 20 fan blades. Moreover, in one disclosed embodiment low pressure turbine 46 includes no more than about 6 turbine rotors schematically indicated at 34. In another non-limiting example embodiment low pressure turbine 46 includes about 3 turbine rotors. A ratio between number of fan blades 42 and the number of low pressure turbine rotors is between about 3.3 and about 8.6. The example low pressure turbine 46 provides the driving power to rotate fan section 22 and therefore the relationship between the number of turbine rotors 34 in low pressure turbine 46 and number of blades 42 in fan section 22 disclose an example gas turbine engine 20 with increased power transfer efficiency.

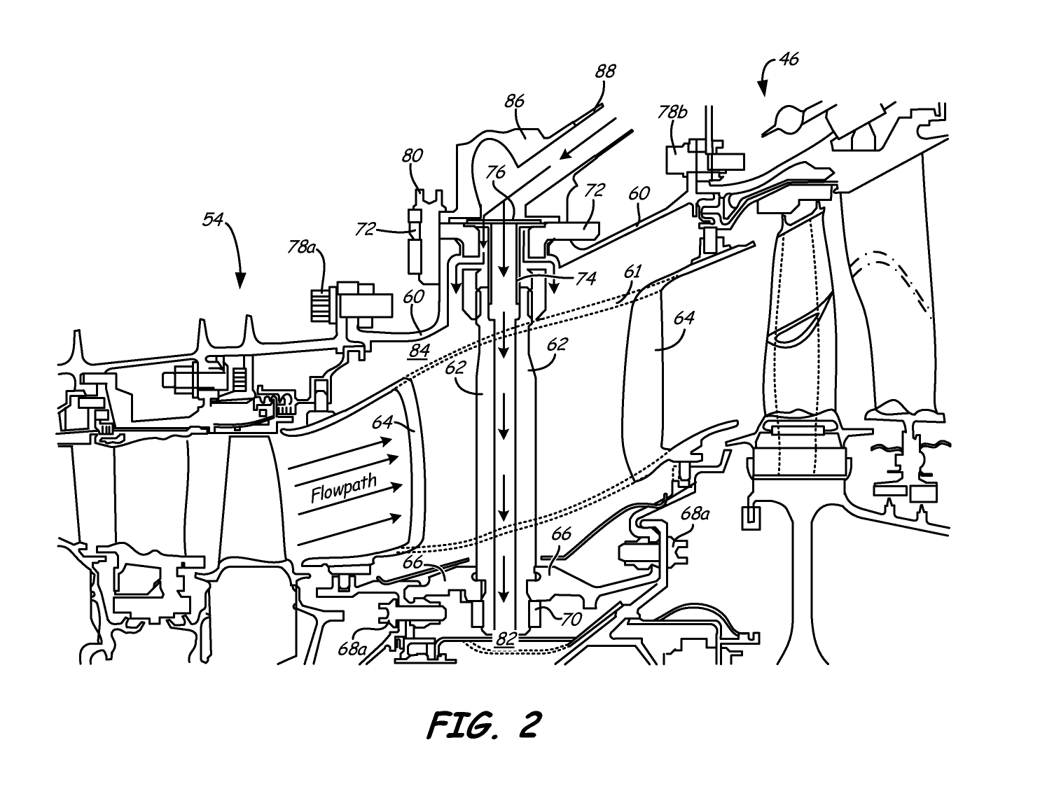

FIG. 2 is a cross-sectional view of mid-turbine frame 58 according to an embodiment of the present invention. In the embodiment shown in FIG. 2, mid-turbine frame 58 includes outer case portion 60, outer flow path wall 61, hollow cooling rod 62, stationary vane 64, inner hub portion 66, inner bolts 68a and 68b, inner diameter i-rod nut 70, outer diameter nut 72, metering tube 74, metering plate 76, outer bolts 78a, 78b, and anti-rotation bolt 80.

As discussed with respect to FIG. 1, mid-turbine frame 58 is located between high-pressure turbine section 54 and low-pressure turbine section 46. Outer case 60 of mid-turbine frame 58 is bolted via outer bolt 78a to high-pressure turbine section 54, and via bolt 78b to low-pressure turbine section 46. Outer flow path wall 61 defines a flowpath (labeled Towpath') for exhaust air provided by combustor 56 (shown in FIG. 1) via high-pressure turbine section 54. Outer diameter portion 84 is defined as the area between outer case 60 and outer flow path wall 61. Within the flowpath defined by outer flow path wall 61, stationary guide vane 64 is positioned to direct the flow of exhaust air from high-pressure turbine section 54 to low-pressure turbine section 46. In the cross-sectional view shown in FIG. 2, only a single stationary guide vane 64 is visible, although a plurality of stationary guide vanes would be positioned circumferentially around the engine centerline to direct the flow of exhaust air from high-pressure turbine section 54 to low-pressure turbine section 46.

Hollow cooling rod 62 is located within stationary vane 64, and provides structural support for mid-turbine frame 58 by communicating loads from the rotor to engine case 60. In particular, hollow cooling rod 62 is fixedly attached to inner hub 66 via inner diameter nut 70. In other embodiments, inner diameter nut may be replaced with bolts for affixing hollow cooling rod 62 to inner hub 66. At a radially outward end, hollow cooling rod 62 is threaded into OD hex nut 72, which includes a flat top portion that rests against outer case 60. By tightening/turning OD hex nut 72, hollow cooling rod 62 is tensioned.

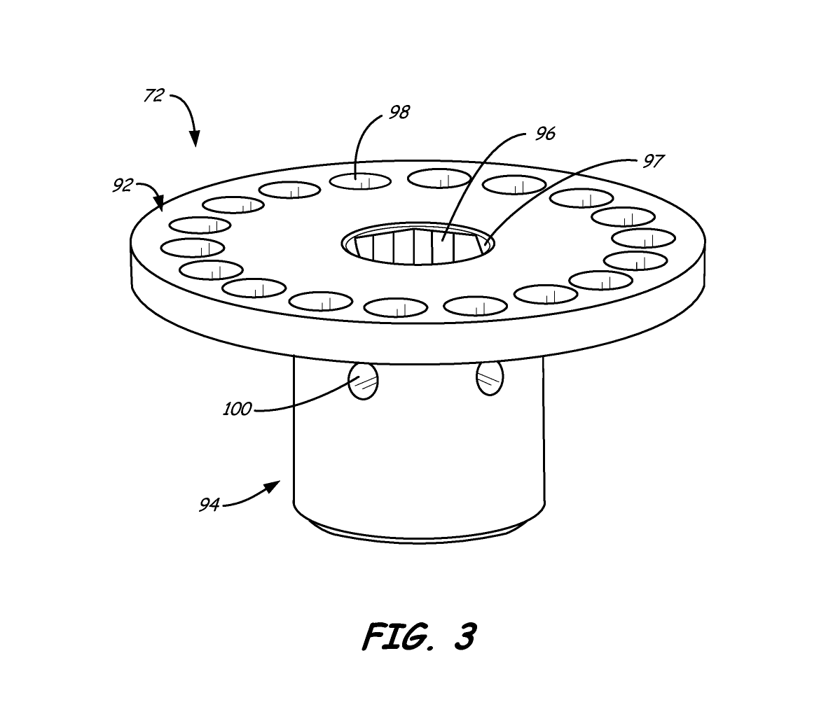

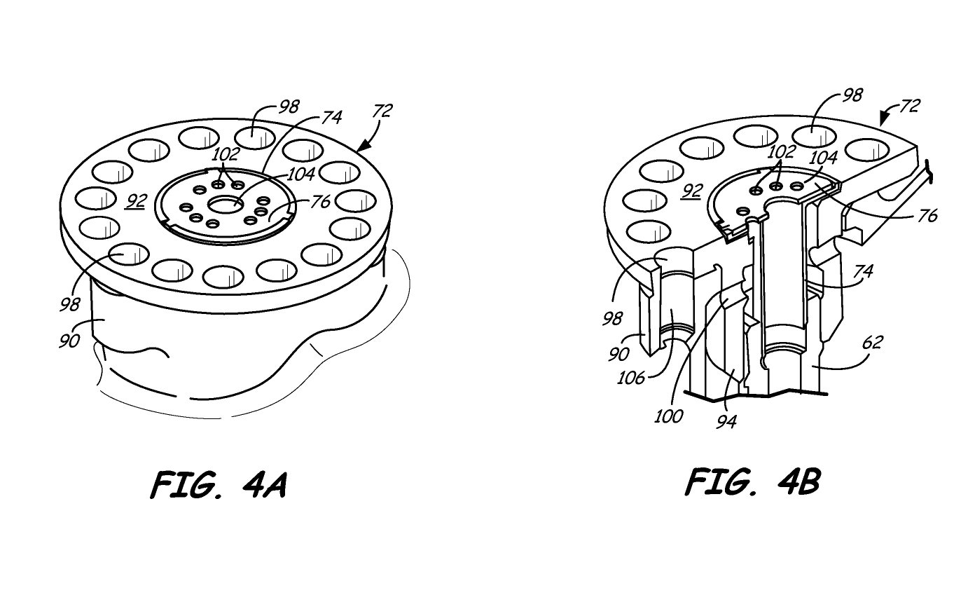

As described in more detail with respect to FIGS. 3 and 4, OD hex nut 72 includes a flange portion that rests against boss portion 90 of outer case 60, and a hollow portion that extends radially inward for threaded engagement with hollow cooling rod 62. The hollow portion of OD hex nut 72 allows cooling airflow to be provided from an outer diameter portion to the interior of hollow cooling rod 62, and via cooling rod 62 to inner diameter portion 82. In addition, OD hex nut includes a plurality of apertures formed on the side of OD hex nut 72 that allow cooling airflow to be directed into outer diameter portion 84. Once OD hex nut 72 has been tightened to provide the desired tension onto hollow cooling rod 62, anti-rotation bolt(s) 80 are used to secure OD hex nut 72 to outer case 60. In addition, anti-rotation bolts 80 secure external manifold 86 to OD hex nut 72. Securing external manifold 86 to a top portion of OD hex nut 72 acts to hold metering plate 76 in place on top of flow metering tube 74. Cooling airflow is delivered to external manifold 86, and then to metering plate 76 and flow metering tube 74 for bifurcation, by cooling pipe 88.

In the embodiment shown in FIG. 2, flow metering tube 74 and metering plate 76 act to bifurcate and meter the cooling airflow provided to and distributed by OD hex nut 72. In particular, flow metering tube 74 includes a top portion that rests against a top portion of OD hex nut 72 and a tube portion that extends radially inward within OD hex nut 72 to hollow cooling rod 62. In this way, the combination of OD hex nut 72 and flow metering plate delivers cooling airflow to the interior portion of hollow cooling rod 62. In addition, flow metering plate 74 includes apertures for bifurcating the cooling airflow and providing cooling airflow to a location exterior to the tube portion of flow metering tube 74, but within the hollow portion of OD hex nut 72. This cooling airflow is distributed via apertures on the side of OD hex nut 72 to radial outward portion 84.

FIG. 3 is an isometric view of OD hex nut 72 according to embodiment of the present invention. OD hex nut 72 includes flange portion 92 and bottom/tube portion 94. Flange portion 92 includes central aperture 96 that provides cooling airflow from an outer diameter source (e.g., external manifold 86 shown in FIG. 2) to the interior of tube portion 94. Although not shown in this view, flow metering tube 74 and flow metering plate 76 would be located within central aperture 96, supported at an outer circumference by ridge portion 97. At least some cooling airflow is bifurcated and distributed to radial outer portion 84 (shown in FIG. 2) via apertures 100 located on the side of tube portion 94. The size and number of apertures 100 are selected to meet the maximum cooling requirements for different applications, wherein any desired metering (i.e., reduction) of the airflow provided to either the inner portion 82 or outer portion 84 is controlled by flow metering tube 74 and/or metering plate 76.

A plurality of apertures 98 (sometimes referred to as “vernier holes”) are located around the outer circumference of flange portion 92, for receiving anti-rotation bolts 80 (shown in FIG. 2). In one embodiment, three anti-rotation bolts are employed to secure OD hex nut 72 to outer case 60. By including a number of additional apertures 98 beyond those utilized by anti-rotation bolts 80, OD hex nut 72 can be tightened to a desired position, with at least one set of apertures 98 aligned with bolt holes on outer case 60. Installation of anti-rotation bolt 80 prevents OD hex nut from rotating, and therefore maintains the desired amount of tension on hollow cooling rod 62.

FIG. 4A is a perspective view of an installed OD hex nut and FIG. 4B is a cross-sectional view of an installed OD hex nut according to an embodiment of the present invention. With respect to FIG. 4A, OD hex nut 72 is located over boss 90, with flanged portion 92 resting on a top surface of boss 90. Flow metering tube 74 is located within a central aperture (not visible in this view) of OD hex nut 72. Metering plate 76 is located over flow metering tube 74, and includes a plurality of apertures 102 and central aperture 104 for bifurcating and metering the cooling airflow.

FIG. 4B is a cross-sectional view of installed OD hex nut 72. The cross-sectional view illustrates alignment between one of the apertures 98 and bolt hole 106 within boss 90. In addition, this view illustrates the threaded connection between tube portion 94 of OD hex nut 72 and hollow cooling rod 62. As OD hex nut 72 is rotated, hollow cooling rod 62 is tensioned, with flange portion 92 securing OD hex nut 72 to outer case 60. Once tensioned a desired amount, whichever aperture 98 is aligned with bolt holes 106 is used to receive anti-rotation bolts 80 (shown in FIG. 2) to secure OD hex nut 72 to outer case 60.

Flow metering tube 74 is also shown in this view, extending within the hollow portion of OD hex nut 72 for engagement with hollow cooling rod 62. In this way, cooling airflow supplied via central aperture 104 is communicated via the tube portion of flow metering tube 74 to hollow cooling rod 62. Meanwhile, cooling airflow provided via apertures 102 is communicated to the hollow region within OD hex nut 72, but outside of flow metering tube 74, wherein the cooling airflow is communicated via apertures 100 to outer diameter region 84 (shown in FIG. 2).

In this way, the present invention provides an apparatus for securing and tensioning a hollow cooling rod within the mid-turbine frame of a gas turbine engine, while also providing a path for providing cooling airflow to desired portions of the engine. In one embodiment, this includes providing cooling airflow to both an outer diameter region and an inner diameter region communicated with via the tensioned hollow cooling rod.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An outer diameter (OD) hex nut for securing a hollow cooling rod to an outer case of an engine, the OD hex nut comprising:
a flange portion comprising:
a central aperture for receiving cooling airflow; and
a plurality of vernier holes located circumferentially around the flange portion; and
a hollow tube portion extending from the flange portion having a hollow portion in fluid communication with the central aperture for receiving cooling airflow, and a plurality of apertures located on a sidewall portion of the hollow tube portion for distributing cooling airflow from the hollow portion to an exterior location.

2. The OD hex nut of claim 1, wherein the hollow tube portion is threaded on a distal end for threaded engagement with a hollow cooling rod.

3. The OD hex nut of claim 2, further including:
a shoulder portion located around the central aperture of the flange portion for supporting a flow metering tube that extends into the hollow tube portion for engagement with the hollow cooling rod.

4. An apparatus for tensioning a hollow cooling rod and distributing cooling airflow to various locations of a mid-turbine frame, the apparatus comprising:
an outer diameter (OD) hex nut having a flange portion and a hollow tube portion, wherein the flange portion includes a central aperture for receiving cooling airflow and a plurality of vernier holes located circumferentially around the central aperture, wherein the hollow tube portion extends from the flange portion and is threaded on one end for threaded engagement with the hollow cooling rod, wherein the hollow tube portion is in fluid communication with the central aperture to deliver cooling airflow to the hollow cooling rod; and
at least one anti-rotation bolt, wherein the at least one anti-rotation bolt is installed in one of the plurality of vernier holes and secured to an outer case of the mid-turbine frame to prevent rotation of the OD hex nut.

5. The apparatus of claim 4, wherein the OD hex nut includes a plurality of side apertures located on the hollow tube portion of the OD hex nut.

6. The apparatus of claim 5, further including:
a flow metering tube located within the central aperture of the OD hex nut that includes a flange portion that is supported by the OD hex nut and a tube portion that extends within the tube portion of the OD hex nut for engagement within the hollow cooling rod; and
a flow metering plate supported by the flow metering tube that includes a central aperture and a plurality of apertures located circumferentially around the flow metering plate, wherein the central aperture supplies cooling airflow to the tube portion of the flow metering tube for supply to the hollow cooling rod, and wherein the plurality of apertures located circumferentially around the flow metering plate direct cooling airflow external to the tube portion of the flow metering tube for communication to an outer diameter of the mid-turbine frame via the plurality of side apertures located on the hollow tube portion of the OD hex nut.

7. A cooling apparatus for a mid-turbine frame, the cooling apparatus comprising:
an outer case;
an inner hub;
a hollow cooling rod that extends from the inner hub to the outer case;
an outer diameter (OD) hex nut having a flange portion and a hollow tube portion, wherein the flange portion supports the OD hex nut against the outer case and includes a central aperture and a plurality of vernier holes, and wherein the hollow tube portion includes a threaded end for threaded engagement with the hollow cooling rod, wherein the OD hex nut is tightened to tension the hollow cooling rod; and
an anti-rotation bolt that is threaded through one of the plurality of vernier holes into a bolt hole on the outer case to prevent the OD hex nut from rotating once installed and tensioned.

8. The cooling apparatus of claim 7, wherein the OD hex nut includes a plurality of side apertures located on the hollow tube portion of the OD hex nut.

9. The cooling apparatus of claim 8, further including:
a flow metering tube located within the central aperture of the OD hex nut that includes a flange portion that is supported by the OD hex nut and a tube portion that extends within the tube portion of the OD hex nut for engagement within the hollow cooling rod; and
a flow metering plate supported by the flow metering tube that includes a central aperture and a plurality of apertures located circumferentially around the flow metering plate, wherein the central aperture supplies cooling airflow to the tube portion of the flow metering tube for supply to the hollow cooling rod, and wherein the plurality of apertures located circumferentially around the flow metering plate direct cooling airflow external to the tube portion of the flow metering tube for communication to an outer diameter of the mid-turbine frame via the plurality of side apertures located on the hollow tube portion of the OD hex nut.

10. The cooling apparatus of claim 9, further including:
an external manifold attached to the OD hex nut that holds the metering plate in place on top of the flow metering tube; and
a cooling pipe that supplies cooling airflow to the external manifold for bifurcation and metering by the flow metering tube and the metering plate.
